(19) United States
(12) Patent Application Publication
(10) Pub. No.: US 2021/0024207 A1
(43) Pub. Date: Jan. 28, 2021

(54) ROTARY WING AERIAL VEHICLE

(71) Applicant: PRODRONE CO., LTD., Nagoya-shi, Aichi (JP)

(72) Inventor: Kiyokazu SUGAKI, Nagoya-shi (JP)

(73) Assignee: PRODRONE CO., LTD., Nagoya-shi, Aichi (JP)

(21) Appl. No.: 16/982,213

(22) PCT Filed: Jun. 14, 2019
(86) PCT No.: PCT/JP2019/023663

§ 371 Date: Sep. 18, 2020

(30) Foreign Application Priority Data
Dec. 7, 2018 (JP) 2018-229765

(51) Int. Cl. B64C 27/57; B64C 39/02; G05D 1/10; G08G 5/00

(52) U.S. Cl. CPC B64C 27/57; B64C 39/024; B64C 2201/108; G08G 5/003; B64C 2201/027; G05D 1/101

(57) ABSTRACT

A rotary wing aerial vehicle including: first and second rotary wings including fixed pitch propellers. A rotational frequency of the first wing has a lower limit, which is controlled at or above the lower limit while flying. A rotational frequency of the second wing is decreasable to or below a frequency where gyro effect or lift force is lost. Also: a plurality of horizontal rotary wings with fixed pitch propellers; and a controller including: all driving mode wherein the vehicle flies with all horizontal wings; and partial driving mode wherein: a rotational frequency of one or more of the horizontal wings is decreased to or below a frequency where gyro effect or lift force is lost; and the vehicle flies using the other wings. If the rotational frequency of a horizontal wing becomes less than a predetermined threshold in all driving mode, the controller automatically switches to partial driving mode.

### TECHNICAL FIELD

The present invention relates to a flight control technique for a rotary wing aerial vehicle.

### BACKGROUND ART

Patent literature 1 listed below discloses an idea of providing a helicopter with an auxiliary rotor for use in a soft landing in a case where the main rotor of the helicopter fails.

### CITATION LIST

### Cited Literature

PTL1: JP4-274995A

### SUMMARY OF INVENTION

### Technical Problem

Multi-copters, which fly using a plurality of horizontal rotary wings, need to have a lift force high enough to stably support the weight of the airframe, including payload. When an amount of lift force is obtained, it is more energy-efficient to rotate a large-diameter propeller at low rpm than to rotate a small-diameter propeller at high rpm. For multi-copters using batteries as motive power source, a problem is the shortness of flight continuation time. Under the circumstances, it is common practice to employ propellers having maximum mountable sizes in such multi-copters.

In multi-copters using propellers with fixed pitch angles (fixed pitch propellers), the lift force each propeller is adjusted by controlling the rotational frequency of each propeller (equivalent in meaning to rotational speed in the present application, which applies in the following description). When a multi-copter that flies using fixed pitch propellers is pushed upward by, for example, an ascending air current while making a flight, the altitude is maintained by decreasing the rotational frequency of each propeller. When the multi-copter is blown by a strong ascending air current, it is, naturally, necessary to decrease the rotational frequency approximately. For a propeller to exhibit its functions, it is necessary to rotate at a level of rotational frequency that enables a sufficient amount of lift force and/or gyro effect to be obtained. If the rotational frequency of a propeller is decreased to below its lower limit, the propeller loses the function of controlling the airframe, turning the multi-copter into non-steerable state. This kind of trouble is more likely to occur especially while the airframe is being descended amid an ascending air current.

In light of the above-described problems, the present invention has an object to improve the stability of an airframe as of flight time with low lift force.

### Solution to Problem

In order to solve the above-described problem, the present invention provides a rotary wing aerial vehicle that includes a plurality of horizontal rotary wings each including a fixed pitch propeller. The plurality of horizontal rotary wings include a first rotary wing and a second rotary wing. The first rotary wing is such a rotary wing that a rotational frequency of the first rotary wing has a lower limit and that the rotational frequency is controlled at or above the lower limit while the rotary wing aerial vehicle is flying. The second rotary wing is such a rotary wing that a rotational frequency of the second rotary wing is decreasable to or below a rotational frequency at which a gyro effect or a lift force is lost.

In some situations such as in a descending manipulation amid an ascending air current, it is necessary to decrease the lift force of the airframe on a large scale. In such situations, if the rotational frequency of propeller is decreased excessively, the function of controlling the airframe may be lost; or the descending manipulation may be unacceptable in order to keep the rotational frequency of the propeller within a safety range. In the rotary wing aerial vehicle according to the present invention, the rotational frequencies of some (first rotary wings) of the horizontal rotary wings are kept within a safety range, and at the same time, the rotational frequencies of the other horizontal rotary wings (second rotary wings) are decreasable to or below a rotational frequency at which a gyro effect or a lift force is lost. This ensures that the lift force of the airframe as a whole can be safely decreased while the function of controlling the airframe is secured.

In this context, in the rotary wing aerial vehicle according to the present invention, the horizontal rotary wings preferably include six or more horizontal rotary wings, and the first rotary wing preferably includes three or four first rotary wings. Further, the horizontal rotary wings more preferably include eight horizontal rotary wings, and the first rotary wing more preferably includes four first rotary wings.

When the rotary wing aerial vehicle includes six or more horizontal rotary wings, the first rotary wing and the second rotary wing according to the present invention are more easily implemented in configuration. In a case of at least three first rotary wings, the airframe can be maintained in a horizontal position, even when the rotary wing aerial vehicle is flying using the first rotary wings alone. In a case of four first rotary wings, the heading direction of the airframe can also be maintained. In particular, in a case where the rotary wing aerial vehicle is an octo-copter including eight horizontal rotary wings that include four first rotary wings, the rotary wing aerial vehicle can be assumed as, for example, a quad-copter including four sets of rotary wing aerial vehicles such that each set is a pair of two adjacent horizontal rotary wings. Under this assumption, the airframe can be controlled by a control method common to the case where the rotary wing aerial vehicle is flying using all the horizontal rotary wings and the case where the rotary wing aerial vehicle is flying using the first rotary wings alone.

Also in order to solve the above-described problem, the present invention provides a rotary wing aerial vehicle that includes: a plurality of horizontal rotary wings each including a fixed pitch propeller; and a controller configured to control driving of the plurality of horizontal rotary wings. The controller has a driving mode for driving the plurality of horizontal rotary wings, the driving mode including: an all driving mode in which the rotary wing aerial vehicle flies with all the horizontal rotary wings driven; and a partial driving mode in which: a rotational frequency of one or more of the horizontal rotary wings is decreased to or below a rotational frequency at which a gyro effect or a lift force is lost; and the rotary wing aerial vehicle flies using the other horizontal rotary wings. If the rotational frequency of one or a plurality of the horizontal rotary wings becomes less than a predetermined threshold while the rotary wing aerial vehicle is flying in the all driving mode, the controller is configured to automatically switch the driving mode to the partial driving mode.

The controller dynamically switches between the all driving mode and the partial driving mode. This ensures that, for example, upon detection of a symptom of an excessive decrease in the amount of lift force necessary for a flight, the controller is able to perform control of swiftly stopping some of the horizontal rotary wings and maintaining the rotational frequencies of the other horizontal rotary wings at high levels. This enables the rotary wing aerial vehicle to fly more safely using the other horizontal rotary wings alone.

Also in the rotary wing aerial vehicle according to the present invention, if the rotational frequency of one or a plurality of the other horizontal rotary wings exceeds a predetermined threshold while the rotary wing aerial vehicle is flying in the partial driving mode, the controller is preferably configured to automatically switch the driving mode to the all driving mode.

The controller automatically performs both the switch from the all driving mode to the partial driving mode and the switch from the partial driving mode to the all driving mode. This configuration enables an operator to manipulate the rotary wing aerial vehicle without paying attention to the driving mode. The configuration also enables the rotary wing aerial vehicle to more safely make an autonomous flight which can not be visually checked and in which it is difficult to switch the driving mode manually.

In this context, in the rotary wing aerial vehicle according to the present invention, the horizontal rotary wings preferably include six or more horizontal rotary wings, and in the partial driving mode, the rotary wing aerial vehicle preferably flies using three or four horizontal rotary wings. Further, the horizontal rotary wings more preferably include eight horizontal rotary wings, and in the partial driving mode, the rotary wing aerial vehicle more preferably flies using four horizontal rotary wings.

When the rotary wing aerial vehicle includes six or more horizontal rotary wings, the driving mode switch function according to the present invention is more easily implemented. In a case where there are at least three horizontal rotary wings driven in the partial driving mode, the airframe can be maintained in a horizontal position. In a case where there are four such horizontal rotary wings, the heading direction of the airframe can also be maintained. In particular, in a case where the rotary wing aerial vehicle is an octo-copter including eight horizontal rotary wings that include four first rotary wings driven in the partial driving mode, the rotary wing aerial vehicle can be assumed as, for example, a quad-copter including four sets of rotary wing aerial vehicles such that each set is a pair of two adjacent horizontal rotary wings. Under this assumption, the airframe can be controlled by a control method common to the case where the rotary wing aerial vehicle is flying in the all driving mode and the case where the rotary wing aerial vehicle is flying in the partial driving mode.

Also, the rotary wing aerial vehicle according to the present invention may be an unmanned aerial vehicle.

Many unmanned aerial vehicles have lightweight airframes, causing such a tendency that the rotational frequencies of the propellers are more likely to reach their lower limit than the rotational frequencies are in manned vehicles. By providing such unmanned aerial vehicles with the configurations of the first rotary wing and the second rotary wing according to the present invention, the flight safety of such unmanned aerial vehicles improves advantageously.

### Advantageous Effects of Invention

Thus, the rotary wing aerial vehicle according to the present invention improves the stability of an airframe as of flight time with low lift force.

### BRIEF DESCRIPTION OF DRAWINGS

FIG. 1 is a perspective view of an exterior of a multi-copter 10 according to a first embodiment.

FIG. 2 is a block diagram illustrating a functional configuration of the multi-copter 10.

FIG. 3 is a schematic illustrating changes in rotational frequencies of rotors 60A and 60B occurring during the flight time of the multi-copter 10.

FIG. 4 a schematic illustrating a driving mode switching method according to a modification of the multi-copter 10.

FIG. 5 is a schematic illustrating changes in the rotational frequencies of the rotors 60A and 60B occurring during the flight time of the multi-copter 10 according to the modification.

FIG. 6 is a perspective view of an exterior of a multi-copter 10a according to a second embodiment.

FIG. 7 is a block diagram illustrating a functional configuration of the multi-copter 10a.

FIG. 8 is a schematic illustrating changes in the rotational frequencies of the rotors 60A and 60B occurring during the flight time of the multi-copter 10a.

FIG. 9 is a schematic illustrating the driving mode switching method according to a modification of the multi-copter 10a.

FIG. 10 is a schematic illustrating changes in the rotational frequencies of the rotors 60A and 60B occurring during the flight time of the multi-copter 10a according to the modification.

### DESCRIPTION OF EMBODIMENTS

Embodiments of the present invention will be described below. The first embodiment and the second embodiment, described below, are examples of an unmanned rotary-wing aerial vehicle that flies using a plurality of horizontal rotary wings. As used in the present invention, the term “horizontal rotary wing” refers to such a rotary wing that the axis direction of a rotation axis extends vertically and that a rotation surface is a horizontal surface. Even if the rotation axis and/or the rotation surface of a horizontal rotary wing are more or less inclined, this horizontal rotary wing is encompassed within the “horizontal rotary wing” according to the present invention insofar as the lift force of the horizontal rotary wing is mainly made up of a vertical component.

### First Embodiment

### Configuration Outline

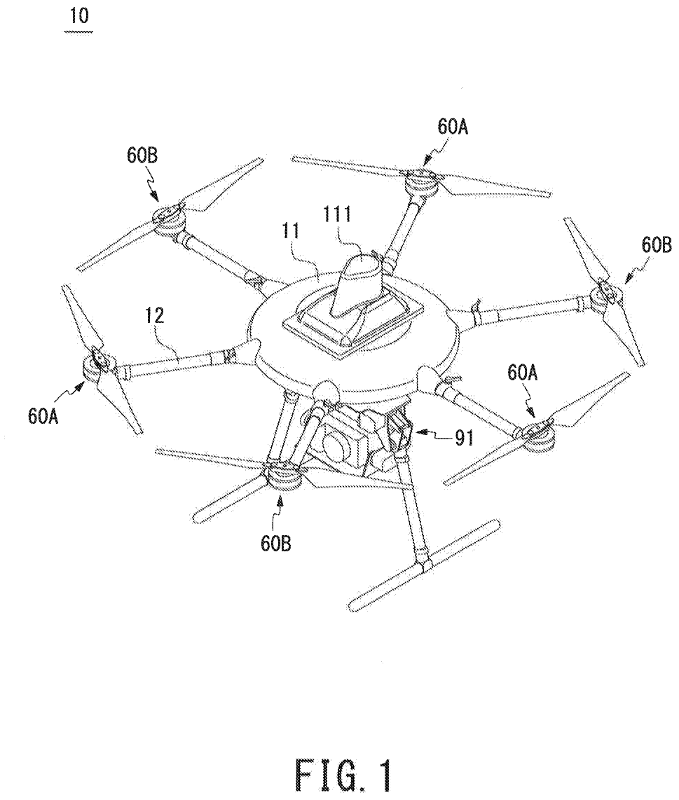

FIG. 1 is a perspective view of an exterior of the multi-copter 10 according to the first embodiment. The multi-copter 10 according to this embodiment is an aerial photography airframe, which takes pictures in the air.

The multi-copter 10 mainly includes: a body 11, which is a central part of the airframe; a plurality of arms 12, which extend radially from the body 11 in plan view; the rotors 60A and 60B, each of which is provided at a leading end portion of a corresponding arm 12; and a camera 91.

The body 11 is a case body having a hollow monocoque structure of approximately disk shape. In the body 11, electronic devices such as a flight controller FC, described later, are incorporated. On the upper surface of the body 11, there is provided an opening through which articles are taken in and out. The opening is covered with a body cover 111, which serves as a lid.

The multi-copter 10 according to this embodiment includes six arms 12. The arms 12 are cylindrical pipe materials made of CFRP (Carbon Fiber Reinforced Plastics). The arms 12 extend in horizontal directions from the body 11 and are arranged at equal intervals in a circumferential direction of the body 11 as if to surround the body 11.

The rotors 60A and 60B are horizontal rotary wings, and each rotor includes: a motor, which is a driving source; and a fixed pitch propeller mounted on the motor. The multi-copter 10 controls the rotational frequency of each of the rotors 60A and 60B to adjust the lift force of each of the rotors 60A and 60B. It is to be noted that the driving source of the horizontal rotary wing will not be limited to a motor but may be an engine.

The camera 91 is a typical camera capable of taking still pictures and movies. The camera 91 is mounted on a posture stabilizer that is a “3-axis gimbal” mounted on the body 11.

### Functional Configuration

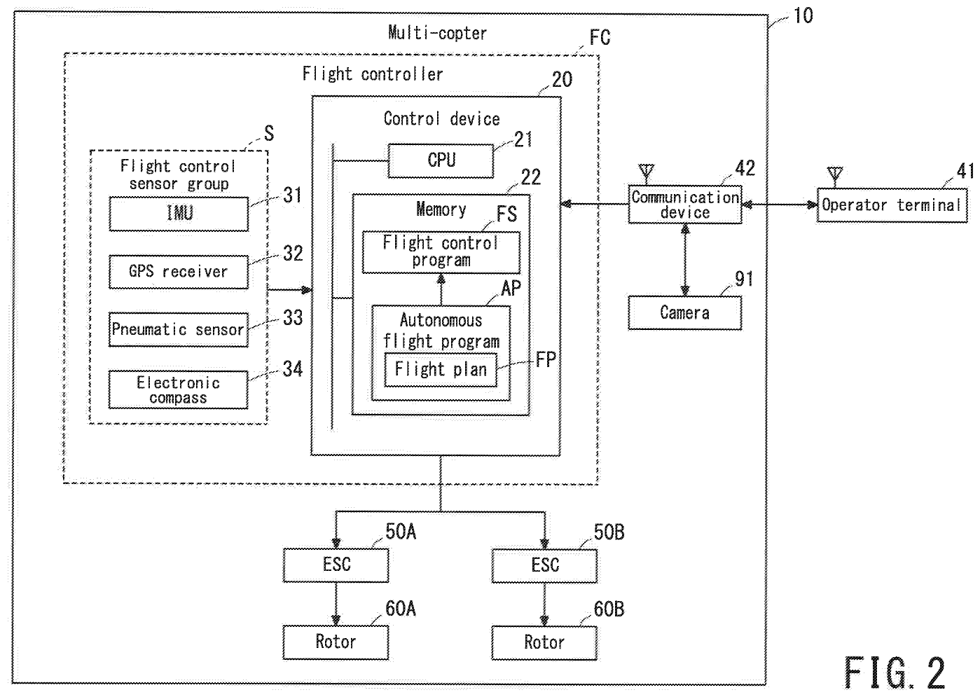

FIG. 2 is a block diagram illustrating a functional configuration of the multi-copter 10. The functions of the multi-copter 10 according to this embodiment include: the flight controller FC, which is a controller; the rotors 60A and 60B; ESCs (Electronic Speed Controllers) 50A and 50B, which are driving circuits for the rotors 60A and 60B, respectively; and a communication device 42, which communicates with the operator (operator terminal 41). It is to be noted that batteries providing supply power to the foregoing elements are not illustrated.

The flight controller FC includes a control device 20. The control device 20 includes: a CPU 21, which is a central processing unit; and a memory 22, which is a storage such as ROM, RAM, and flash memory.

The flight controller FC further includes a flight control sensor group S, which includes an IMU 31 (Inertial Measurement Unit), a GPS receiver 32, a pneumatic sensor 33, and an electronic compass 34. These elements are connected to the control device 20.

The IMU 31 is a sensor that detects a slope of the multi-copter 10, and mainly includes a three-axis acceleration sensor and a three-axis angular velocity sensor. The GPS receiver 32 is, in a strict sense, a receiver in Navigation Satellite System (NSS). The GPS receiver 32 obtains current longitude and latitude values from Global Navigation Satellite System (GNSS) or Regional Navigation Satellite System (RNSS). The pneumatic sensor 33 is an altitude sensor that identifies the sea level altitude (height) of the multi-copter 10 based on an air pressure altitude that has been detected. In this example, a 3-axis geomagnetic sensor is used as the electronic compass 34. The electronic compass 34 detects the azimuth angle of the airframe nose of the multi-copter 10.

The flight controller FC is capable of obtaining, using the flight control sensor group S, position information indicating the position of the airframe including: the inclination of the airframe; the rotation of the airframe; the longitude and latitude of the airframe in flight; the altitude of the airframe in flight; and the azimuth angle of the airframe nose in flight.

It is to be noted that the flight control sensor group S according to this embodiment has been provided for exemplary purposes, and the sensors constituting the flight controller FC will not be limited to the combination described in this embodiment. For example, it is possible to use, instead of the pneumatic sensor 33 or in addition to the pneumatic sensor 33, a laser distance measuring sensor or a stereo camera to measure ground altitude with the sensor or the camera pointed downward. It is also possible to use, in places where the GPS receiver 32 can not receive electric waves, an optical flow sensor or image recognition to detect a horizontal movement of the airframe. Another possible example is to: measure the distance to a surrounding object using a plurality of distance measuring sensors that utilize laser, infrared light, or ultrasonic; and identify a spatial position of the multi-copter 10 based on the distance.

The control device 20 includes a flight control program FS, which is a program for controlling the posture of the multi-copter 10 during flight and controlling basic flight operations. The flight control program FS adjusts the rotational frequency of each of the rotors 60A and 60B based on information obtained from the flight control sensor group S, and causes the multi-copter 10 to fly while correcting the posture and/or position of the airframe.

The control device 20 further includes an autonomous flight program AP, which is a program for causing the multi-copter 10 to fly autonomously. In the memory 22 of the control device 20, a flight plan FP is registered. The flight plan FP includes parameters specifying: longitude and latitude of the destination and/or a transit point of the multi-copter 10; and altitude and/or speed of the multi-copter 10 in flight. The autonomous flight program AP causes the multi-copter 10 to fly autonomously based on the flight plan FP, under the starting condition that an instruction has been transmitted from the operator terminal 41 or time has passed to reach a predetermined point of time.

Thus, the multi-copter 10 according to this embodiment is an unmanned aerial vehicle having high-level flight control functions. It is to be noted, however, that the rotary wing aerial vehicle according to the present invention will not be limited in form to the multi-copter 10; for example, it is possible to use an airframe with some of the sensors omitted from the flight control sensor group S or use an airframe without an autonomous flight function and capable of flying by manual operation only.

### Low Lift Force Flight Function

A low lift force flight function of the multi-copter 10 will be described below. The rotors of the multi-copter 10 include the rotor 60A and the rotor 60B. The rotor 60A is the first rotary wing according to the present invention. As used herein, the term “first rotary wing” refers to such a rotary wing that a lower limit is set to the rotational frequency of the rotary wing and that the rotational frequency is controlled at or above the lower limit while the rotary wing aerial vehicle is flying. The rotor 60B is the second rotary wing according to the present invention. As used herein, the term “second rotary wing” refers to such a rotary wing that the rotational frequency of the rotary wing is decreasable to or below a rotational frequency at which a gyro effect or a lift force is lost. As used herein, the phrase “to or below a rotational frequency at which a gyro effect or a lift force is lost” encompasses a stopping (zero rotational frequency). As illustrated in FIG. 1, the multi-copter 10 according to this embodiment is a hexacopter that includes three rotors 60A and three rotors 60B.

A lower limit of m is set to the rotational frequency of the rotor 60A according to this embodiment. The lower limit m is such that even if there is an excessive decrease in the amount of lift force necessary for a flight such as when, for example, the airframe is descending amid an ascending air current, a horizontal position of the airframe is managed to be maintained by the lift force of the rotor 60A alone. It is to be noted that the lower limit m may be the average of the rotational frequencies of all the rotors 60A, or may be set to an individual rotor 60A. In contrast, no lower limit is set to the rotational frequency of the rotor 60B, that is, the rotational frequency is decreasable to the degree that the rotor 60B comes to a stop.

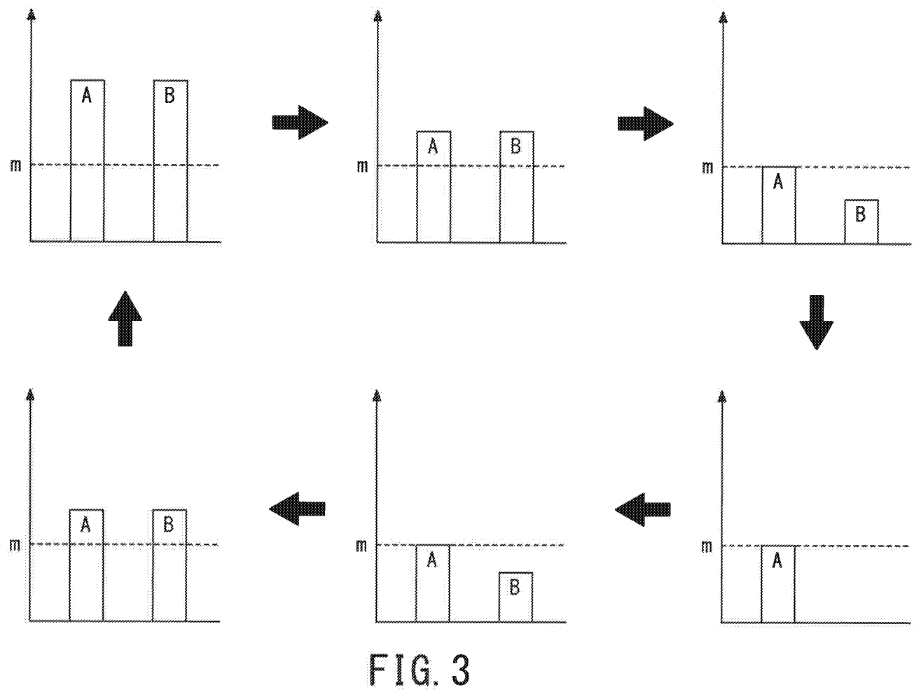

FIG. 3 is a schematic illustrating changes in the rotational frequencies of the rotors 60A and 60B occurring during the flight time of the multi-copter 10. In the graphs illustrated in FIG. 3, the value indicated “A” is the average of the rotational frequencies of the three rotors 60A, and the value indicated “B” is the average of the rotational frequencies of the three rotors 60B. The vertical axis of each graph indicates the magnitude of the rotational frequency. At the lower end of the vertical axis, the rotational frequency is zero, and the rotational frequency increases as it moves farther away from the lower end along the vertical axis. The graphs illustrated in FIG. 3 will be described below in clockwise order, starting from the upper left graph.

(Upper left graph) In normal environment, the multi-copter 10 flies with both the rotors 60A and 60B driven, with no difference in flight method from a typical hexacopter. (Upper middle graph) Upon implementation of a descending manipulation by the operator, the flight controller FC decreases the rotational frequencies of the rotors 60A and 60B until the altitude of the multi-copter 10 starts decreasing. (Upper right graph) If the multi-copter 10 does not start descending due to, for example, a strong ascending air current, the flight controller FC further decreases the rotational frequencies of the rotors 60A and 60B. Once the rotational frequency of the rotor 60A reaches the lower limit m, the rotational frequency of the rotor 60A is not decreased any further, and is kept at the lower limit m. In contrast, the rotational frequency of the rotor 60B is decreased limitlessly until the rotor 60B comes to a stop. (Lower right graph) As a result, the rotor 60B comes to a stop, and the flight controller FC attempts to make the multi-copter 10 descend using the rotor 60A alone. In this context, since there are three rotors 60A in this embodiment, the rotors 60A narrowly manage to maintain the horizontal position of the airframe, but the torque yawing direction becomes partial, making the airframe rotate while descending. (Lower middle graph) If, for example, the flight environment returns to normal and the lower limit m of the rotational frequency of the rotor 60A is not enough to cover the necessary lift force, the flight controller FC restarts driving of the rotor 60B. (Lower left graph) If the rotational frequency of the rotor 60B increases to a level equivalent to the lower limit m of the rotational frequency of the rotor 60A, and if the resulting rotational frequencies are still not enough to cover the lift force, the rotational frequencies of both the rotor 60A and the rotor 60B are increased. Thus, in the multi-copter 10 according to this embodiment, a flight using both the rotors 60A and 60B and a flight using the rotor 60A alone are seamlessly switched.

Thus, the multi-copter 10 according to this embodiment includes the rotors 60A and 60B, which have two different kinds of rotational frequency lower limits. This ensures that the rotational frequency of one rotor (rotor 60A) is kept within a safety range while at the same time the rotational frequency of the other rotor (rotor 60B) is decreasable to or below a rotational frequency at which a gyro effect or a lift force is lost. This ensures that the lift force of the airframe as a whole can be decreased to a significantly low level while a minimum possible airframe control function is secured.

It is to be noted that while the multi-copter 10 according to this embodiment is an unmanned aerial vehicle, the multi-copter 10 may be a manned aerial vehicle. Many unmanned aerial vehicles have lightweight airframes, and the rotational frequency of the rotor is more likely to reach its lower limit than the rotational frequency of the rotor of a manned vehicle. In this embodiment of the present invention, the configurations of the first rotary wing (rotor 60A) and the second rotary wing (rotor 60B) are implemented in an unmanned aerial vehicle. As a result, the unmanned aerial vehicle advantageously improves in flight safety.

### Modification

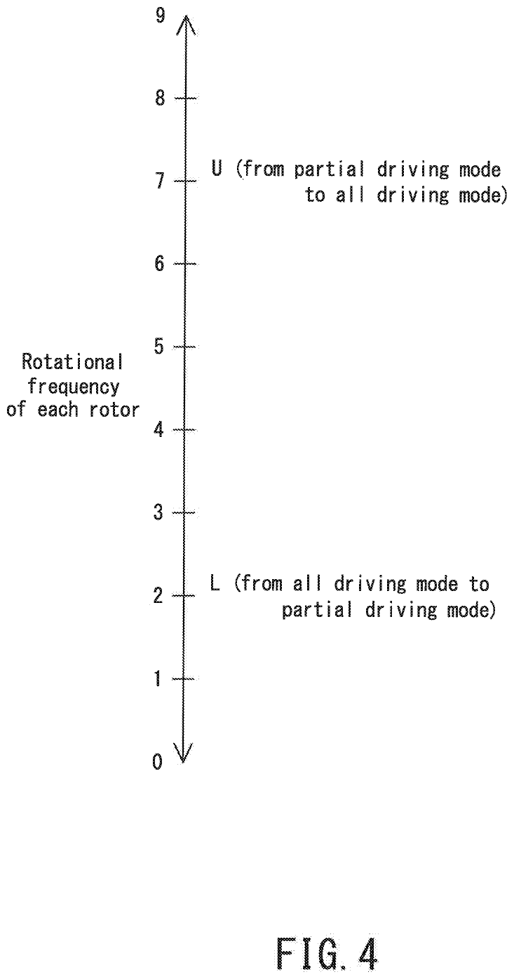

A modification of the low lift force flight function of the multi-copter 10 will be described. FIG. 4 is a schematic illustrating a driving mode switching method for the rotors 60A and 60B performed by the flight controller FC according to this modification. It is to be noted that while the rotor 60A according to this modification is identical in structure to the rotor 60A according to the above-described embodiment, no lower limit is set to the rotational frequency of the rotor 60A according to this modification, since this rotor 60A is not the first rotary wing according to the present invention.

In the above-described embodiment, a lower limit of m is set to the rotational frequency of the rotor 60A, and a flight using both the rotors 60A and 60B and a flight using the rotor 60A alone are switched seamlessly based on the flight environment. In the multi-copter 10 according to this modification, there is a distinction between: an all driving mode, in which the multi-copter 10 flies with all the rotors 60A and 60B driven; and a partial driving mode, in which the multi-copter 10 flies with the rotor 60B stopped and only the rotor 60A driven. The flight controller FC explicitly switches between these driving modes based on a predetermined condition.

The vertical axis of the graph illustrated in FIG. 4 indicates the magnitude of the rotational frequencies of the rotors 60A and 60B. At the lower end of the vertical axis, the rotational frequency is zero, and the rotational frequency increases as it moves farther away from the lower end along the vertical axis. If the rotational frequency of the rotor 60A or 60B decreases below a predetermined threshold L while the multi-copter 10 is flying in the all driving mode, the flight controller FC according to this modification automatically switches the driving mode to the partial driving mode. If the rotational frequency of any of the rotors 60A exceeds a predetermined threshold U while the multi-copter 10 is flying in the partial driving mode, the flight controller FC according to this modification automatically switches the driving mode to the all driving mode.

In this modification, the threshold L is set at a rotational frequency to which the rotational frequencies of the rotors 60A and 60B are not expected to reach in normal flight environment. That is, in this modification, the partial driving mode is positioned as an emergency removal measure used when an abnormality has occurred in the flight environment, such as a strong ascending air current and a gust.

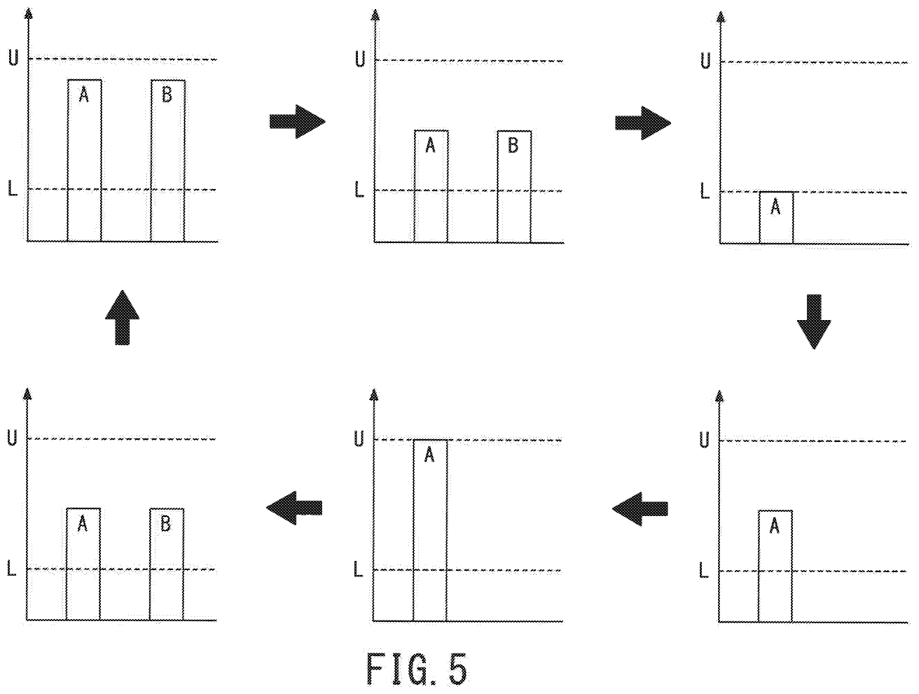

FIG. 5 is a schematic illustrating changes in the rotational frequencies of the rotors 60A and 60B occurring during the flight time of the multi-copter 10 according to this modification. In the graphs illustrated in FIG. 5, the value indicated “A” is the rotational frequency of the rotor 60A, and the value indicated “B” is the rotational frequency of the rotor 60B. It is to be noted that while the rotational frequencies of the rotors 60A and 60B vary independently depending on steering in the actual operation, the following description takes, by way of description, a representative one value of the rotational frequency of the rotor 60A and a representative one value of the rotational frequency of the 60B. The vertical axis of each graph indicates the magnitude of the rotational frequency. At the lower end of the vertical axis, the rotational frequency is zero, and the rotational frequency increases as it moves farther away from the lower end along the vertical axis. The graphs illustrated in FIG. 5 will be described below in clockwise order, starting from the upper left graph.

(Upper left graph) The multi-copter 10 is flying in the all driving mode, and all the rotational frequencies of the rotors 60A and 60B are at or above the threshold L (a rotational frequency of 2 in FIG. 4). Here, there is no difference in the flight method of the multi-copter 10 from the previous embodiment. It is to be noted that at the time of take-off, the multi-copter 10 according to this modification is set to take off in the all driving mode, instead of the partial driving mode. (Upper middle graph) If the airframe is blown by, for example, a gust, the flight controller FC decreases the rotational frequencies of the rotors 60A and 60B in order to maintain the altitude. (Upper right graph) Then, if the rotational frequency of any one of the rotors 60A and 60B decreases below the threshold L, the flight controller FC switches the driving mode to the partial driving mode, stopping the rotor 60B purposefully. It is to be noted that the rotor 60A or 60B whose rotational frequency has decreased below the threshold Lis a single rotor and that the rotational frequencies of the other rotors 60A and 60B are higher than the threshold L. (Lower right graph) In this context, by stopping the rotor 60B, the rotational frequency of the rotor 60A increases. (Lower middle graph) Then, the flight controller FC continues the flight in the partial driving mode until the rotational frequency of any of the rotors 60A exceeds the threshold U (a rotational frequency of 7 in FIG. 4). In this context, if, for example, the flight environment returns to normal and a sufficient amount of lift force can not be obtained in the partial driving mode, the rotational frequency of the rotor 60A increases rapidly. (Lower left graph) Then, if the rotational frequency of any of the rotors 60A exceeds the threshold U, the flight controller FC switches the driving mode to the all driving mode, restarting driving of the rotor 60B. This ensures that the rotational frequency of the rotor 60A is decreased to an appropriate value.

In the previous embodiment, the rotational frequency of the rotor 60A in the flight using the rotor 60A alone is kept at the lower limit m. In this modification, the flight controller FC distinctively switches between the all driving mode and the partial driving mode. This ensures that the rotational frequency of the rotor 60A is kept at high levels even in the flight using the rotor 60A alone. Specifically, upon detection of a symptom of an excessive decrease in the amount of lift force necessary for a flight, the flight controller FC swiftly stops the rotor 60B. This prevents the rotational frequency of the rotor 60A from reaching the lower limit, which is provided for safety purposes. This makes the flight using the rotor 60A alone safer. Also, in this modification, the flight controller FC automatically performs the switch from the all driving mode to the partial driving mode and the switch from the partial driving mode to the all driving mode. This configuration enables the operator to manipulate the multi-copter 10 without paying attention to the driving mode. The configuration also enables the multi-copter 10 to more safely make an autonomous flight which can not be visually checked and in which it is difficult to switch the driving mode manually.

It is to be noted that the threshold L, at which the all driving mode is switched to the partial driving mode, and the threshold U, at which the partial driving mode is switched to the all driving mode, will not be limited to the values used in this modification, and that the thresholds may be changed approximately based on the specifications of the airframe and/or the flight environment. Also, while in this modification the rotor 60B is stopped in the partial driving mode, the rotor 60B may not necessarily be stopped but may be made to run idly at low speed. Also, the flight controller FC according to this modification switches the all driving mode to the partial driving mode if the rotational frequency of any one of the rotors 60A and 60B decreases below the threshold L. Another possible example is that the flight controller FC according to this modification makes the switch if the rotational frequencies of two or more of the rotors 60A and 60B decrease below the threshold L or if the average of the rotational frequencies of the rotors 60A and 60B decreases below the threshold L. Similarly, the flight controller FC according to this modification switches the partial driving mode to the all driving mode if the rotational frequency of any one of the rotors 60A exceeds the threshold U. Another possible example is that the flight controller FC according to this modification makes the switch if the rotational frequencies of two or more of the rotors 60A exceed the threshold U or if the average of the rotational frequencies of the rotors 60A exceeds the threshold U.

### Second Embodiment

### Configuration Outline

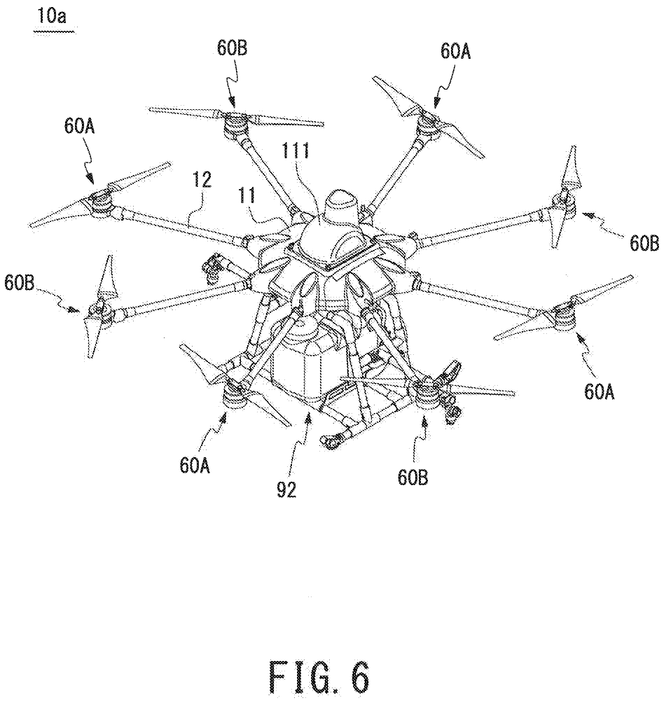

Another embodiment of the rotary wing aerial vehicle according to the present invention will be described below. FIG. 6 is a perspective view of an exterior of a multi-copter 10a according to the second embodiment. The multi-copter 10a according to this embodiment is a pesticide applicator that sprays a pesticide filling a liquid tank. It is to be noted that in the following description, identical or similar configurations in the first and second embodiments will be denoted with like reference numerals and will not be elaborated upon here.

The multi-copter 10a mainly includes: a body 11, which is a central part of the airframe; a plurality of arms 12, which extend radially from the body 11 in plan view; rotors 60A and 60B, each of which is provided at a leading end portion of a corresponding arm 12; and a pump device 92. Similarly to the multi-copter 10 according to the first embodiment, the rotor 60A is the first rotary wing according to the present invention, and the rotor 60B is the second rotary wing according to the present invention.

The body 11 is a case body having a hollow monocoque structure of approximately disk shape. In the body 11, electronic devices such as a flight controller FC are incorporated. On the upper surface of the body 11, there is provided an opening through which articles are taken in and out. The opening is covered with a body cover 111, which serves as a lid.

The multi-copter 10a according to this embodiment includes eight arms 12. The arms 12 are cylindrical pipe materials made of CFRP. The arms 12 extend in horizontal directions from the body 11 and are arranged at equal intervals in a circumferential direction of the body 11 as if to surround the body 11.

The rotors 60A and 60B are horizontal rotary wings, and each rotor includes: a motor, which is a driving source; and a fixed pitch propeller mounted on the motor. The multi-copter 10 controls the rotational frequency of each of the rotors 60A and 60B to adjust the lift force of each of the rotors 60A and 60B.

The pump device 92 sprays the pesticide in the liquid tank through a spray nozzle. The multi-copter 10a flies while spraying the pesticide until the full liquid tank becomes empty. As a result, there is a large difference between the pre-spraying aircraft weight and the post-spraying aircraft weight.

### Functional Configuration

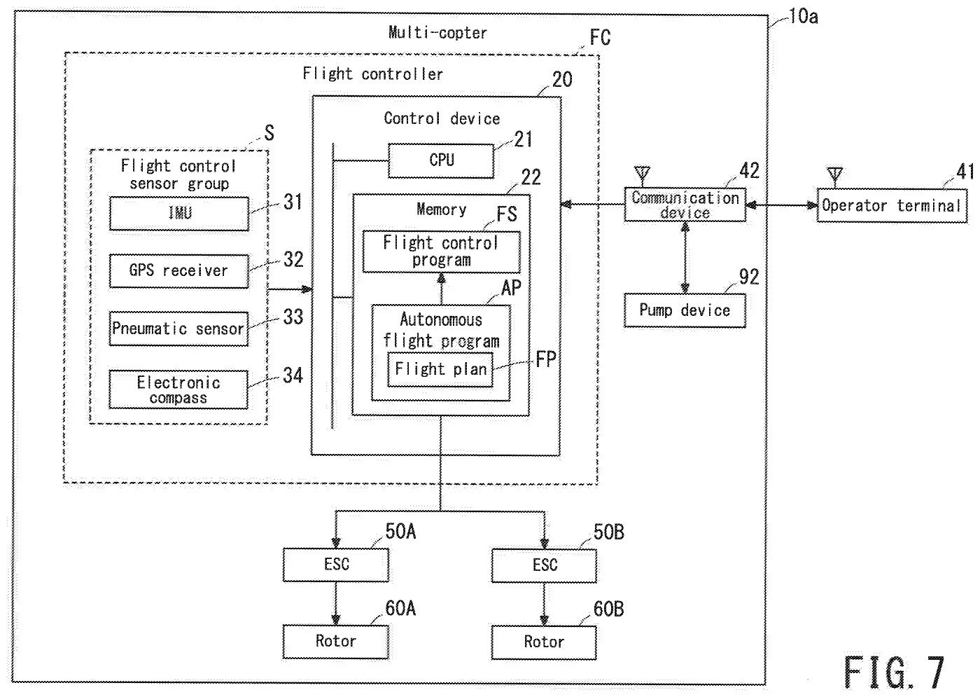

FIG. 7 is a block diagram illustrating a functional configuration of the multi-copter 10a. Functional differences between the multi-copter 10a and the multi-copter 10 according to the first embodiment are only the following respects: the camera 91, which is an external device, is replaced with the pump device 92; a different number of rotors 60A and 60B are used; and the flight control method differs because of the foregoing differences.

### Low Lift Force Flight Function

A low lift force flight function of the multi-copter 10a will be described. As illustrated in FIG. 6, the multi-copter 10a according to this embodiment is an octo-copter and includes four rotors 60A and four rotors 60B.

The flight controller FC according to this embodiment controls the multi-copter 10a as if the multi-copter 10a is a quad-copter including four sets of rotors 60A and 60B such that each set is a pair of two adjacent rotors 60A and 60B. This ensures that the airframe can be controlled by a control method common to the flight using all the rotors 60A and 60B and the flight using the rotor 60A alone. The multi-copter 10a according to this embodiment is similar to the multi-copter 10 according to the first embodiment in that the flight using both the rotors 60A and 60B and the flight using the rotor 60A alone are seamlessly switched.

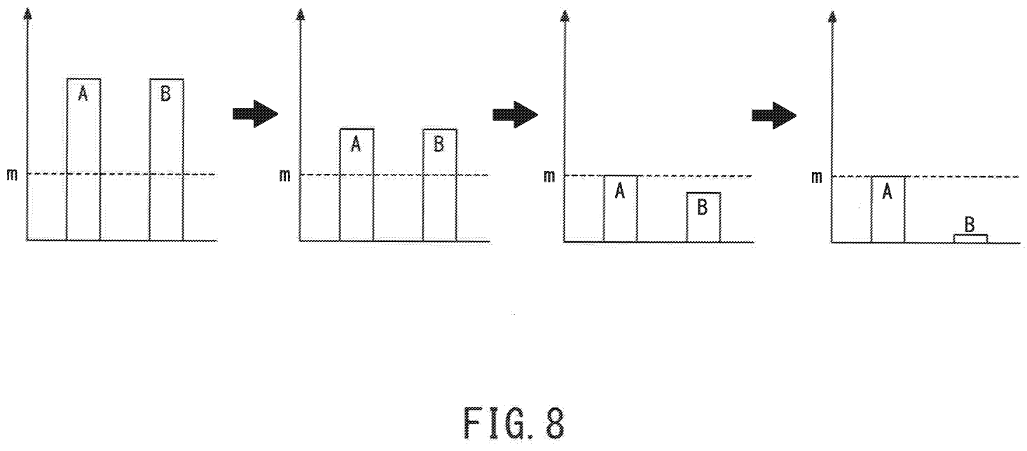

FIG. 8 is a schematic illustrating changes in the rotational frequencies of the rotors 60A and 60B occurring during the flight time of the multi-copter 10a. FIG. 8 is similar to FIG. 3, which is the first embodiment, in terms of the reference numeral and what are intended by the values in the graphs. Description will be made below with regard to FIG. 8, starting from the left end graph toward the right end graph.

(Left end graph) The multi-copter 10a whose liquid tank is filled with a pesticide flies with both the rotors 60A and 60B driven. There is no difference in flight method between the multi-copter 10a and a typical octo-copter. (Left middle graph) Once the spraying of the pesticide starts, the weight of the airframe gradually decreases. In order to maintain the flight altitude of the multi-copter 10a constant, the flight controller FC gradually decreases the rotational frequencies of the rotors 60A and 60B. (Right middle graph) As the liquid tank becomes close to empty state, the rotational frequency of the rotor 60A reaches the lower limit m, and the rotational frequency of the rotor 60B is further decreased. (Right end graph) When the multi-copter 10a lands with the liquid tank in empty state, the rotor 60B is substantially stopped. It is to be noted that the lower limit m of the rotational frequency of the rotor 60A is set such that the horizontal position of the airframe is maintained even using the rotor 60A alone. In this context, since the multi-copter 10a includes four rotors 60A, the multi-copter 10a is able to descend while maintaining not only the horizontal position of the airframe but also the orientation of the heading.

### Modification

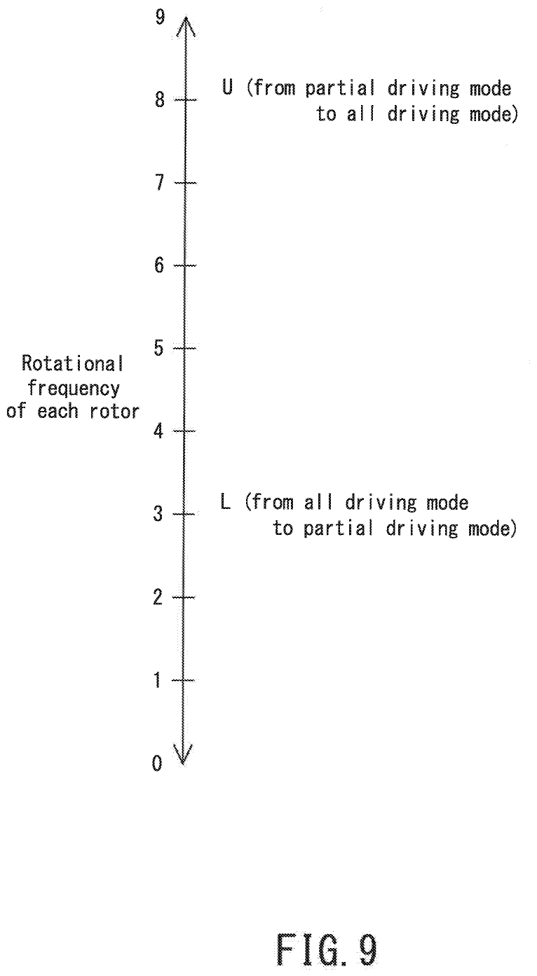

A modification of the low lift force flight function of the multi-copter 10a will be described below. FIG. 9 is a schematic illustrating the driving mode switching method for the rotors 60A and 60B performed by the flight controller FC according to this modification. FIG. 9 is similar to FIG. 4, which is the first embodiment, in terms of the reference numeral and what are intended by the values in the graphs. It is to be noted that while the rotor 60A according to this modification is identical in structure to the rotor 60A according to the second embodiment, no lower limit is set to the rotational frequency of the rotor 60A according to this modification, since this rotor 60A is not the first rotary wing according to the present invention.

In the multi-copter 10a according to this modification, there is a distinction between: an all driving mode, in which the multi-copter 10a flies with all the rotors 60A and 60B driven; and a partial driving mode, in which the multi-copter 10a flies with the rotor 60B stopped and only the rotor 60A driven. If the rotational frequency of any one of the rotors 60A and 60B decreases below a predetermined threshold L while the multi-copter 10 is flying in the all driving mode, the flight controller FC according to this modification automatically switches the driving mode to the partial driving mode. If the rotational frequency of any one of the rotors 60A exceeds a predetermined threshold U while the multi-copter 10 is flying in the partial driving mode, the flight controller FC according to this modification automatically switches the driving mode to the all driving mode.

In this modification, the threshold L is set at a rotational frequency (a rotational frequency of 3 in FIG. 9) that the rotational frequencies of the rotors 60A and 60B reach the liquid tank becomes close to empty state. That is, in this modification, the partial driving mode is not an emergency removal measure used when an abnormality has occurred in the flight environment; the partial driving mode is a driving mode used in normal pesticide spraying work in normal flight environment. Also, the multi-copter 10a according to this modification flies using four rotors 60A even in the partial driving mode and thus is able to make any kind of steering including ascending of the airframe. That is, as long as the multi-copter 10a is able to fly in the partial driving mode, it is not necessary to return the driving mode to the all driving mode. Under the circumstances, the rotational frequency threshold U (a rotational frequency of 8 in FIG. 9), at which the partial driving mode is switched to the all driving mode, is set at a value higher than the threshold U according to the first embodiment.

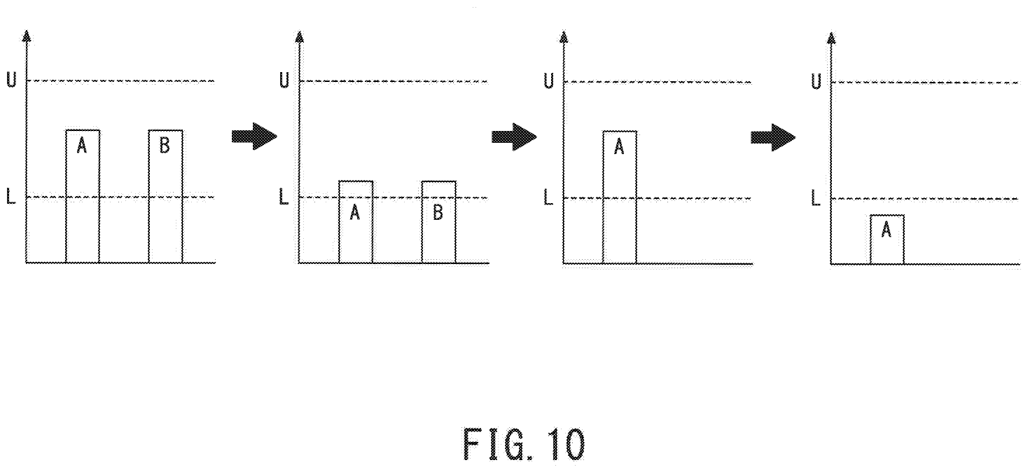

FIG. 10 is a schematic illustrating changes in the rotational frequencies of the rotors 60A and 60B occurring during the flight time of the multi-copter 10a according to this modification. FIG. 10 is similar to FIG. 5, which is the first embodiment, in terms of the reference numeral and what are intended by the values in the graphs. Description will be made below with regard to FIG. 10, starting from the left end graph toward the right end graph.

(Left end graph) The multi-copter 10a whose liquid tank is filled with a pesticide flies with both the rotors 60A and 60B driven. There is no difference in flight method between the multi-copter 10a and a typical octo-copter. It is to be noted that at the take-off time, the multi-copter 10a according to this modification starts in the partial driving mode. If the lift force in the partial driving mode is not enough to enable the multi-copter 10a to take off, the partial driving mode is switched to the all driving mode by making the rotational frequency of the rotor 60A reach the threshold U. (Left middle graph) Once the spraying of the pesticide starts, the weight of the airframe gradually decreases. In order to maintain the flight altitude of the multi-copter 10a constant, the flight controller FC gradually decreases the rotational frequencies of the rotors 60A and 60B. (Right middle graph) When the liquid tank becomes close to empty state and the rotational frequency of any one of the rotors 60A and 60B decreases below the threshold L, the flight controller FC switches the driving mode to the partial driving mode, stopping the rotor 60B purposefully. In this context, by stopping the rotor 60B, the rotational frequency of the rotor 60A increases. (Right end graph) Then, the multi-copter 10a ends the work in the partial driving mode, with the rotational frequency of the rotor 60A not reaching the threshold U. Then, the multi-copter 10a lands.

While the embodiments of the present invention have been described hereinbefore, the present invention will not be limited in scope to these embodiments, and numerous modifications and variations are possible without departing from the spirit of the invention. For example, while in the above-described embodiments a hexacopter and an octo-copter have been taken as examples, the number of horizontal rotary wings will not be limited to six or eight.

1. A rotary wing aerial vehicle comprising a plurality of horizontal rotary wings each comprising a fixed pitch propeller,
wherein the plurality of horizontal rotary wings comprise a first rotary wing and a second rotary wing,
wherein the first rotary wing is such a rotary wing that a rotational frequency of the first rotary wing has a lower limit and that the rotational frequency is controlled at or above the lower limit while the rotary wing aerial vehicle is flying, and
wherein the second rotary wing is such a rotary wing that a rotational frequency of the second rotary wing is decreasable to or below a rotational frequency at which a gyro effect or a lift force is lost.

2. The rotary wing aerial vehicle according to claim 1,
wherein the horizontal rotary wings comprise six or more horizontal rotary wings, and
wherein the first rotary wing comprises three or four first rotary wings.

3. The rotary wing aerial vehicle according to claim 2,
wherein the horizontal rotary wings comprise eight horizontal rotary wings, and
wherein the first rotary wing comprises four first rotary wings.

4. A rotary wing aerial vehicle comprising:
a plurality of horizontal rotary wings each comprising a fixed pitch propeller; and
a controller configured to control driving of the plurality of horizontal rotary wings,
wherein the controller has a driving mode for driving the plurality of horizontal rotary wings, the driving mode comprising:
an all driving mode in which the rotary wing aerial vehicle flies with all the horizontal rotary wings driven; and
a partial driving mode in which: a rotational frequency of one or more of the horizontal rotary wings is decreased to or below a rotational frequency at which a gyro effect or a lift force is lost; and the rotary wing aerial vehicle flies using the other horizontal rotary wings, and
wherein if the rotational frequency of one or a plurality of the horizontal rotary wings becomes less than a predetermined threshold while the rotary wing aerial vehicle is flying in the all driving mode, the controller is configured to automatically switch the driving mode to the partial driving mode.

5. The rotary wing aerial vehicle according to claim 4, wherein if the rotational frequency of one or a plurality of the other horizontal rotary wings exceeds a predetermined threshold while the rotary wing aerial vehicle is flying in the partial driving mode, the controller is configured to automatically switch the driving mode to the all driving mode.

6. The rotary wing aerial vehicle according to claim 4,
wherein the horizontal rotary wings comprise six or more horizontal rotary wings, and
wherein in the partial driving mode, the rotary wing aerial vehicle is configured to fly using three or four of the six or more horizontal rotary wings.

7. The rotary wing aerial vehicle according to claim 6,
wherein the horizontal rotary wings comprise eight horizontal rotary wings, and
wherein in the partial driving mode, the rotary wing aerial vehicle is configured to fly using four of the eight horizontal rotary wings.

8. The rotary wing aerial vehicle according to claim 1, wherein the rotary wing aerial vehicle comprises an unmanned aerial vehicle.

9. The rotary wing aerial vehicle according to claim 4, wherein the rotary wing aerial vehicle comprises an unmanned aerial vehicle.
